(19) United States
(12) Patent Application Publication
(10) Pub. No.: US 2007/0258204 A1
(43) Pub. Date: Nov. 8, 2007

(54) Reel device and the electronic product using the same

(75) Inventors: Sheng-Hsiung Chang, Taipei (TW); Ya-Chin Chen, Taipei (TW); Kuo-Chou Chiu, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/797,460

(22) Filed: May 3, 2007

(30) Foreign Application Priority Data
May 5, 2006 (TW) 95116126

(51) Int. Cl. G06F 1/16

(52) U.S. Cl. 361/683

(57) ABSTRACT

A reel device is disposed inside an electronic product, such as computer host, laptop, etc. The reel device comprises a wire winder, a transmission cable, a signal terminal, and a connector. The transmission cable is reeled inside the wire winder. The signal terminal joined one end of the transmission cable is connected on the circuit board of the electronic product to be signal transmission channel. A connector joined to the other end of the transmission cable is exposed outside of the wire winder. The housing of the electronic product further has an opening. The connector and the transmission cable can be pulled out of the electronic product, and then the connector is plugged into a connector of another electronic product to transmit signals.

### BACKGROUND OF THE INVENTION

(1) Field of the Invention

The present invention relates to a reel device, more particularly to a reel device disposed inside an electronic product.

(2) Description of the Prior Art

With the advancement of the science and technology, the performance of a personal computer is getting better, and computer peripherals weed out the old fashion to bring forth the new fashion constantly. A computer can also be a integrating and control center to connect various computer peripheral products in addition to the powerful processing ability. The computer can utilize various transmission interfaces to connect other input/output devices, such as printer, MP3 player, digital camera, mobile phone, storage device, etc.

Beside, some devices with the plug and play function are gradually independent from the computer or laptop to meet the trend of the electronic products development, such as slim volume and weight, etc. The devices, such as external CD-ROM driver, external hard disk, floppy disk unit, and so on, connect to the computer by means of external connection.

By way of the above external devices, it not only makes the computer and the laptop be simplified, but also makes the storage devices have the features of portability and compatibility. For example, users can input or output data from different computers by an external hard disk. That is, the users only carry the external hard disk to copy the data from a computer, and then input the data to another computer.

However, taking a transmission line as a medium to transmit signals is necessary when electronic products need to transmit signals or data each other, or the above external device connects to the computer.

The transmission line in the market is an independent accessory and includes a transmission cable and two connectors joined to both ends of the transmission cable respectively. The above two connectors are individually plugged in another two connectors disposed in two electronic products for forming a signal transmission channel. Generally speaking, the type of above two connectors is different, and they match the connectors that they plug in.

A so-call retractable transmission line is available in the market recently. The retractable transmission line and a conventional transmission line are the same in function, wherein the distinguishing feature of the retractable transmission line is applied on a wire winder. The retractable transmission line mainly comprises a wire winder, a transmission cable reeled inside the wire winder, two connectors, such as male and female connectors, joined to two ends of the transmission cable and exposed outside of the wire winder.

While users pull the two connectors outwardly, the transmission cable reeled inside the wire winder is then pulled out. If the transmission cable is pulled with a certain length, the length can be held. Thus, the users can pull out a needed length of the transmission cable according to an actual demand. Besides, the users can pull the transmission cable outwardly with a short period of length and loose his finger-tips immediately, the transmission cable is then reeled back in the wire winder by way of the shrinkage force of the wire winder.

However, the transmission line is very important to external electronic products. But, there are some inconveniences as following while in use.

A transmission line is an independent accessory and is not embedded in the electronic product. Therefore, when using an external device, the users must find a transmission line matching with the connector of the external device, otherwise the external device cannot be connected to the computer.

Because of the difference of the transmission interfaces, there are different kinds of connectors disposed on the different electronic products. Hence, the different applications of the different transmission lines cause the problems of gathering and classifying the transmission lines.

Sometimes, an excess length of the transmission line is required since the distant demand is different. But once the length of the transmission line is too long, it is very easily to cause intertwine and disorder. Even though the excessive length of the transmission line is collected and tied in a bundle, but still not for specious consideration.

The transmission line is an independent accessory, so the user often needs to pay additional budget to get one. Moreover, if the user is careless, the transmission line is easily lost, and then the user must pay for it again.

According to the disadvantages of the above prior art, the present invention mainly provides a reel device disposed inside the electronic product to solve the above problems.

### SUMMARY OF THE INVENTION

According to the disadvantages of the above prior art, an objective of the present invention is to provide a reel device applied to an electronic product, so that it is convenient for users to use the needed transmission cable and connectors.

Another objective of the present invention is to provide the reel device disposed inside the electronic product to avoid the inconvenience selecting the needed connectors.

Another objective of the present invention is to provide the device for receiving the extended transmission cable so as to receive the extended transmission cable easily.

According to the above objectives, the present invention provides the reel device disposed inside the electronic product. The connector and the transmission cable joined to the connector can be pulled out of the electronic product so as to transmit signals to the other electronic products. The above reel device includes the following components.

The wire winder is disposed inside the electronic product and has an aperture. The transmission cable is reeled inside the wire winder and can be pulled out of the wire winder via the aperture. A signal terminal is joined to an end of the transmission cable and exposed outside of the wire winder to connect to a circuit board of the electronic product. The signal terminal is a signal transmission channel between the transmission cable and the electronic product. A connector is joined to the otherend of the transmission cable and exposed outside of the wire winder.

The electronic product has an opening. The connector and the transmission cable joined to the above connector can be pulled out of the electronic product via the opening, and then the connector connects to a connector of another electronic product for transmitting signals and data. Users can pull the needed length of the transmission cable according to the actual demand of length. The users can pull the transmission cable outwardly with a short period of length and loose his finger-tips immediately, the transmission cable is then reeled back in the wire winder by way of the shrinkage force of the wire winder.

The above present invention can achieve the needed efficacy according to different embodiments.

In an embodiment of the present invention, the above reel device is embedded in a computer host. For the preferred embodiment, the reel device can be disposed in a position, where is a predetermined socket for optical disk drive, such as CD-ROM/DVD-ROM drive. The signal terminal connects to a circuit board in advance, and then the circuit board has a signal transmission channel for transmitting signals to the motherboard of the computer host. Beside, the panel of the computer host has an opening for providing a passageway that the connector and the transmission cable joined to the connector can be pulled out of the computer host.

In another embodiment of the present invention, the reel device is embedded in a laptop and adjacent to a side of the laptop. The signal terminal connects to the motherboard of the system unit of the laptop. Beside, the side of the system unit has an opening for providing a passageway that the connector and the transmission cable joined to the connector can be pulled out of the laptop.

These and other objectives of the invention will no doubt become obvious to those of ordinary skill in the art after reading the following detailed description of the preferred embodiment, which is illustrated in the various figures and drawings.

### BRIEF DESCRIPTION OF THE DRAWINGS

The present invention will now be specified with reference to its preferred embodiment illustrated in the drawings, in which:

FIG. 1 illustrating a schematic diagram of a reel device disposed inside an electronic product of the present invention;

FIG. 2 illustrating a schematic diagram of the reel device disposed inside a computer host of the present invention; and

FIG. 3 illustrating a schematic diagram of the reel device disposed inside a laptop of the present invention.

### DESCRIPTION OF THE PREFERRED EMBODIMENT

The present invention provides a reel device disposed inside an electronic product for replacing a transmission line in the market. By means of the present invention, a connector and a transmission cable joined to the connector can be pulled out of the electronic product, and the connector can connect to a connector of another electronic product so as to transmit the signals between the products.

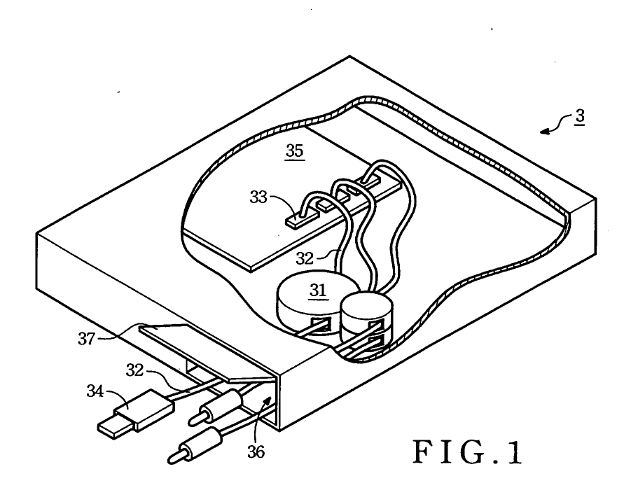

Please refer to FIG. 1, which is a schematic diagram of a reel device disposed inside an electronic product of the present invention. The reel device includes a wire winder 31, a transmission cable 32, a signal terminal 33, and a connector 34.

The wire winder 31 disposed inside a housing of the electronic product 3 has at least an aperture. The transmission cable 32 reeled inside the wire winder 31 can be pulled out of the wire winder 31 via the aperture, wherein the transmission cable 32 is a laminar cable. The signal terminal 33 joined to an end of the transmission cable 32 is exposed outside of the wire winder 31 and connected to a circuit board 35. As a result, the signal terminal 33 is a signal transmission channel between the transmission cable 32 and the electronic product 3. For example, the signal terminal 33 can be the electronic connector formed by a plurality of pins. The connector 34 joined to the otherend of the transmission cable 32 is exposed outside of the wire winder 31.

Wherein the circuit board 35 has a signal transmission channel for transmitting signals to a motherboard of the electronic product 3. In an alternative embodiment, the circuit board 35 is the motherboard of the electronic product. Besides, the wire winder 31 is fixed on the housing of the electronic product 3 by way of screwing.

The housing of the electronic product 3 has an opening (not shown in FIG. 1). The connector 34 and the transmission cable 32 joined to the connector 34 can be pulled out of the electronic product 3 via the opening, and then connects to a connector of another electronic product so as to transmit signals.

Users can pull out a needed length of the transmission cable 32 according to an actual demand length. The users can pull the transmission cable 32 outwardly with a short period of length and loose his finger-tips immediately, the transmission cable 32 is then reeled back in the wire winder 31 by way of the shrinkage force of the wire winder 31.

It is noted that an accommodation 36 for interlinking the above opening is disposed inside the housing of the electronic product 3. When the reel device is not in use, the connector 34 is received in the accommodation 36. A movable cover 37 is disposed on the housing of the electronic product 3 for covering the accommodation 36 and keeping the electronic product 3 pleasing in appearance.

A plurality of reel devices are disposed inside the same electronic product 3 in order to provide a plurality of transmission interfaces. The connector 34 can be selected from one of the group of audio line plug, universal serial bus (USB) plug, mini universal serial bus (mini USB) plug, and so on.

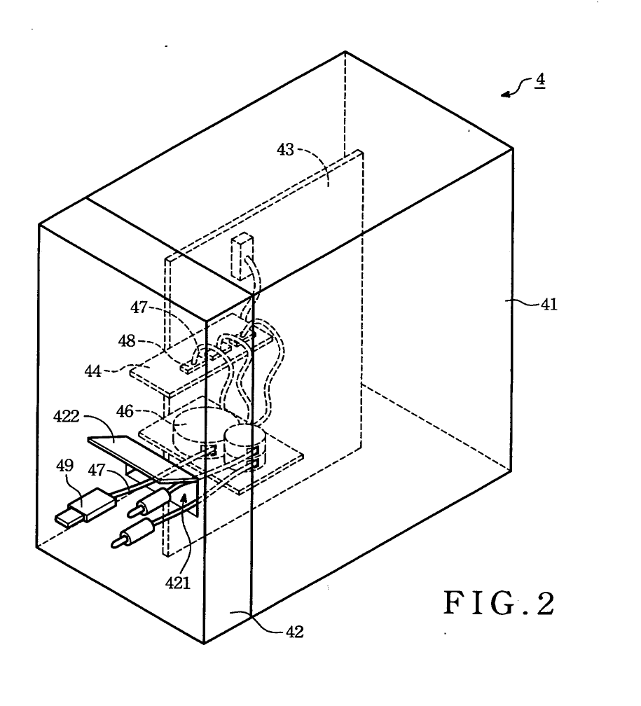

Please refer to FIG. 2, which is a schematic diagram of the reel device disposed inside a computer host of the present invention. This embodiment of the present invention is applied to a computer host 4. The computer host 4 includes a case 41, a panel 42, and a reel device.

The case 41 of the computer host mainly contains important electric devices, such as motherboard 43, hard discs, CD-ROM/DVD-ROM drive, etc. The panel 42 is connected to the front of the case 41 and provides a passageway, which lets the electronic devices in the case 41 be connected to outside, for example, a power button, a connector, and so on.

The reel device is disposed inside the panel 42. In a preferred embodiment of the present invention, the reel device can be disposed at a predetermined socket for optical disk drive, such as CD-ROM/DVD-ROM drive. The wire winder 46 is fixed on the structure of the case or the panel by way of screwing.

The signal terminal 48 is connected to a circuit board 44. The circuit board 44 has a signal transmission channel for transmitting signals to the motherboard 43 of the computer host 4. The panel 42 has an opening (not shown in FIG. 2), the connector 49 and the transmission cable 47 can be pulled out of the computer host 4 via the opening.

The panel 42 has an accommodation 421 for interlinking the opening so as to receive the connector 49 therein. Besides, the panel 42 further has a movable cover 422 disposed on the surface of the panel 42 for covering the accommodation 421, thereby to keep the computer host 4 more pleasing in appearance.

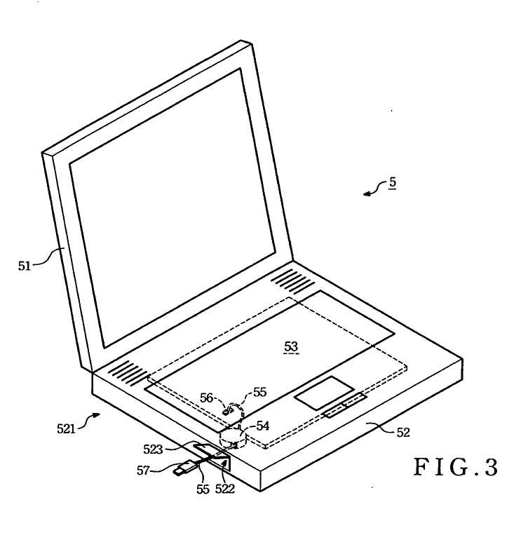

Please refer to FIG. 3, which is a schematic diagram of the reel device disposed inside a laptop of the present invention. In this embodiment, the present invention is applied to a laptop 5, and the reel device is disposed inside the laptop 5. The laptop 5 includes a display unit 51, a system unit 52, and a reel device.

The display unit 51 mainly includes a display panel. The system unit 52 includes a motherboard 53, a keyboard, etc. The reel device is disposed inside the system unit 52 and adjacent to a side of the system unit 52. A wire winder 54 is fixed on the structure of a case of the system unit 52 by way of screwing.

A signal terminal 56 of the reel device is mainly connected to the motherboard 53. Besides, the side of the system unit 52 has a opening (not shown in FIG. 3), the connector 57 and the transmission cable 55 joined to the connector 57 can be pulled out of the system unit 52 via the opening.

The side of the system unit 52 has an accommodation 522 for interlinking the opening so as to receive the connector 57 therein. The laptop 5 further has a movable cover 523 disposed on the side of the system unit 52 for covering the accommodation 522, thereby to keep the laptop 5 more pleasing in appearance.

A computer and a laptop are powerful data processing and multimedia center and can connect with various computer peripheral products, such as printer, digital camera, ipod, flash disk, external storage device, etc. Thus, the computer and the laptop need different kinds of signal transmission channels.

As a result, a plurality of reel devices are disposed inside the computer or the laptop in order to provide different connectors for providing a plurality of transmission interfaces to match different kinds of transmission specification for different computer peripheral products. The connector can be selected from one of the group of audio line plug, universal serial bus (USB) plug, mini universal serial bus (mini USB) plug, and so on.

Moreover, it is reachable to regard the reel device of the present invention as a module with a housing. The reel device can be changed the sizes of the wire winders, the types of the transmission cables, and the types of the connectors to meet the demands of different electronic products.

As a conclusion, the reel device of the present invention applied to an electronic product, such as computer host, laptop, etc, has some advantages as following.

Because the reel device is disposed inside the electronic product, the users do not need to carry any transmission line. The users have only to pull out the connector and the transmission cable joined to the connector and connect to another electronic device. At the same time, the users do not worry about losing the transmission line and buy it again.

Because of the reel device of the present invention, transmission cable will be no longer tangle in a disorder manner, the users will be able to pull out the connector and transmission cable joined to the connector or let the transmission cable be reeled inside the wire winder automatically, thereby to make the entire operation more easily and conveniently.

In the present invention, several reel devices can be disposed in an electronic product to provide different kinds of transmission channels and connectors. For an external device, the present invention brings many conveniences and diversities in application.

With the example and explanations above, the features and spirits of the invention are hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A reel device for an electronic product, comprising:
a wire winder being disposed inside a housing of said electronic product and having at least an aperture;
a transmission cable being reeled inside said wire winder and pulled out of said wire winder via said aperture, wherein said transmission cable is a laminar cable;
a signal terminal joined to a first end of said transmission cable being exposed outside of said wire winder and connected to a circuit board; and
a connector joined to a second end of said transmission cable being exposed outside of said wire winder, wherein said housing has an opening, said connector and said transmission cable can be pulled out of said electronic product via said opening.

2. The reel device of claim 1, wherein said circuit board has a signal transmission channel for transmitting signals to a motherboard of said electronic product.

3. The reel device of claim 1, wherein said circuit board is a motherboard of said electronic product.

4. The reel device of claim 1, wherein said connector can be one of the following: audio line plug, universal serial bus (USB) plug, and mini universal serial bus (mini USB) plug.

5. The reel device of claim 1, wherein said signal terminal is an electric connector formed by a plurality of pins.

6. The reel device of claim 1, wherein a plurality of said reel devices are disposed inside said electronic product for providing a plurality of transmission interfaces.

7. A computer host, comprising:
a case;
a panel being connected to the front of said case and providing a passageway, which lets electronic devices inside said case be connected to outside;
a reel device being disposed inside said panel, comprising:
a wire winder having at least an aperture,
a transmission cable being reeled inside said wire winder and pulled out of said wire winder via said aperture,
a signal terminal joined to a first end of said transmission cable being exposed outside of said wire winder and connected to a circuit board, and
a connector joined to a second end of said transmission cable being exposed outside of said wire winder, wherein said panel has an opening, said connector and said transmission cable can be pulled out of said case via said opening.

8. The computer host of claim 7, wherein said circuit board has a signal transmission channel for transmitting signals to a motherboard of said computer host.

9. The computer host of claim 7, wherein said reel device can be disposed at a predetermined optical disk drive socket.

10. The computer host of claim 7, wherein said panel has an accommodation for interlinking said opening so as to receive said connector.

11. The computer host of claim 10, wherein said computer host further has a movable cover disposed on the surface of said panel for covering said accommodation.

12. The computer host of claim 7, wherein said connector can be one of the following: audio line plug, universal serial bus (USB) plug, and mini universal serial bus (mini USB) plug.

13. The computer host of claim 7, wherein said wire winder is fixed on the structure of said case or said panel.

14. The computer host of claim 7, wherein a plurality of said reel devices are disposed inside said computer host for providing a plurality of transmission interfaces.

15. A laptop comprising:
a display unit;
a system unit, comprising:
a motherboard,
a reel device being disposed inside said system unit and adjacent to a side of said system unit, comprising:
a wire winder having at least an aperture,
a transmission cable being reeled inside said wire winder and pulled out of said wire winder via said aperture,
a signal terminal joined to a first end of said transmission cable being exposed outside of said wire winder and connected to said motherboard, and
a connector joined to a second end of said transmission cable being exposed outside of said wire winder, wherein said side of said system unit has an opening, said connector and said transmission cable can be pulled out of said system unit via said opening.

16. The laptop of claim 15, wherein said side of said system unit has an accommodation for interlinking said opening so as to receive said connector.

17. The laptop of claim 16, wherein said laptop further has a movable cover disposed on said side of said system unit for covering said accommodation.

18. The laptop of claim 15, wherein said connector can be one of the following: audio line plug, universal serial bus (USB) plug, and mini universal serial bus (mini USB) plug.

19. The laptop of claim 15, wherein said wire winder is fixed on the structure of a case of said system unit.

20. The laptop of claim 15, wherein the plurality of reel devices are disposed inside said laptop for providing a plurality of transmission interfaces.
